(19) United States
(12) Patent Application Publication
(10) Pub. No.: US 2012/0238434 A1
(43) Pub. Date: Sep. 20, 2012

(54) SILICA GLASS CONTAINING TIO2

(75) Inventors: Akio Koike, Tokyo (JP); Takahiro Mitsumori, Tokyo (JP); Tomonori Ogawa, Tokyo (JP)

(73) Assignee: ASAHI GLASS COMPANY, LIMITED, Tokyo (JP)

(21) Appl. No.: 13/486,485

(22) Filed: Jun. 1, 2012

Related U.S. Application Data
(63) Continuation of application No. PCT/JP10/70944, filed on Nov. 24, 2010.

(30) Foreign Application Priority Data
Dec. 1, 2009 (JP) 2009-273340

(51) Int. Cl. C03C 3/06

(52) U.S. Cl. 501/54

(57) ABSTRACT

The present invention relates to a TiO₂-containing silica glass containing TiO₂ in an amount of from 5 to 10 mass % and at least one of B₂O₃, P₂O₅ and S in an amount of from 50 ppb by mass to 5 mass % in terms of the total content.

### TECHNICAL FIELD

The present invention relates to a TiO₂-containing silica glass (hereinafter referred to as “TiO₂—SiO₂ glass” in the present description), and in particular, to a TiO₂—SiO₂ glass used as an optical member of an exposure tool for EUV lithography. The EUV (extreme ultraviolet) light as referred to in the present invention means light having a wavelength in a soft X-ray region or a vacuum ultraviolet region, specifically light having a wavelength of from about 0.2 to 100 nm.

### BACKGROUND ART

In the photolithography technology, an exposure tool for manufacturing an integrated circuit by transferring a minute circuit pattern onto a wafer has hitherto been widely utilized. With the trend toward a higher degree of integration and higher function of an integrated circuit, the refinement of the integrated circuit is advancing. The exposure tool is hence required to form a circuit pattern image with high resolution on a wafer surface at a long focal depth, and shortening of the wavelength of an exposure light source is being advanced. The exposure light source is further advancing from conventional g-line (wavelength: 436 nm), i-line (wavelength: 365 nm) and a KrF excimer laser (wavelength: 248 nm), and an ArF excimer layer (wavelength: 193 nm) is coming to be employed. Also, in order to cope with a next-generation integrated circuit whose line width of the circuit pattern will become 70 nm or less, an immersion lithography technique and a double exposure technique, each using an ArF excimer laser, are regarded as being leading. However, it is considered that even these techniques would be able to cover only the generation with a line width of up to 45 nm.

Under the foregoing technical trends, a lithography technique using, as an exposure light source, light having a wavelength of 13 nm to represent EUV light (extreme ultraviolet light) is considered to be applicable over generation in which a line width of the circuit pattern is 32 nm and thereafter, and is attracting attention. The principle of image formation of EUV lithography (hereinafter referred to as “EUVL”) is identical with that of the conventional lithography from the viewpoint that a mask pattern is transferred using a projection optical system. However, since there is no material capable of transmitting light therethrough in the EUV light energy region, a refractive optical system cannot be used. Accordingly, the optical systems are all reflecting optical systems.

The optical member of an exposure tool for EUVL includes a photomask and a mirror and is basically configured with (1) a substrate, (2) a reflective multilayer formed on the substrate and (3) an absorber layer formed on the reflective multilayer. For the reflective multilayer, forming an Mo/Si reflective multilayer in which an Mo layer and an Si layer are alternately laminated is investigated; and for the absorber layer, Ta and Cr are investigated as a layer-forming material. For the substrate, a material having a low coefficient of thermal expansion is required so as not to generate a strain even under irradiation with EUV light, and a glass having a low coefficient of thermal expansion or the like is investigated.

The TiO₂—SiO₂ glass is known as an extremely low thermal expansion material having a coefficient of thermal expansion (coefficient of thermal expansion: CTE) lower than that of a silica glass. Also, since the coefficient of thermal expansion can be controlled by the TiO₂ content in glass, a zero-expansion glass whose coefficient of thermal expansion is close to 0 can be obtained. Accordingly, the TiO₂—SiO₂ glass involves a possibility as a material to be used in an optical member (optical member for EUVL) of an exposure tool for EUVL.

However, one of the drawbacks of the TiO₂—SiO₂ glass body is that the glass body has striae (see, Patent Document 1). Striae are a compositional inhomogeneity (composition distribution) which adversely affects light transmission in an optical member for EUVL produced using the glass body. Striae can be measured by a microprobe that measures compositional variations correlating to coefficient of thermal expansion variations of a few ppb/° C.

Striae have been found to sometimes exert a strong effect when an EUVL optical member for EUVL produced using a TiO₂—SiO₂ glass body is finished to have a surface roughness (PV value) of a several nanometer level. This is a problem, because the optical surface of an optical member for EUVL must be finished to have a very low surface roughness (PV value). Here, the optical surface of an optical member for EUVL indicates a deposition surface on which a reflective multilayer film is formed at the time of producing a photomask or a mirror by using the optical member for EUVL. In this connection, the profile of the optical surface differs depending on the usage of the optical member for EUVL. In the case of an optical member for EUVL for use in the production of a photomask, the optical surface is usually a flat surface, whereas in the case of an optical member for EUVL for use in the production of a mirror, the optical surface is a curved surface in many cases.

Accordingly, in order to use a TiO₂—SiO₂ glass body for an optical member for EUVL, striae must be reduced.

Patent Document 1 discloses that generation of striae can be reduced by incorporating from 0.0001 to 1 mass % of a viscosity-reducing dopant into a TiO₂—SiO₂ glass having a TiO₂ content of from 5 to 12 mass %. Patent Document 1 discloses, as the viscosity-reducing dopant, a metal or a nonmetal dopant selected from the group consisting of an alkali, an alkaline earth, aluminum, fluorine and other metals (La, Y, Zr, Zn, Sn, Sb, and P) that do not produce strong coloration, and an alkali metal selected from the group consisting of K, Na, Li, Cs, and Rb.

However, the TiO₂—SiO₂ glass described in Patent Document 1 contains a component having characteristics improper for use as an optical substrate for EUVL. Specifically, an alkali metal and an alkaline earth metal have a problem that growth of cristobalite as a crystal phase of SiO₂ or growth of rutile or anatase as a crystal phase of TiO₂ readily occurs in the glass forming process and generation of so-called devitrification is involved. Furthermore, these components are responsible also for the problem of an inclusion such as foreign matter and bubble in the produced TiO₂—SiO₂ glass. As for aluminum, La, Y, Zr and the like, it is considered that when an oxide thereof is contained in the glass, the viscosity of the glass is rather increased and generation of striae cannot be prevented.

### RELATED ART

### Patent Document

Patent Document 1: JP-A-2008-037743

### SUMMARY OF THE INVENTION

### Problems that the Invention is to Solve

In order to solve those problems of the above conventional techniques, an object of the present invention is to provide a TiO₂—SiO₂ glass suitable for an optical member for EUVL, which can be prevented from generation of striae without causing a problem of devitrification or inclusion.

### Means for Solving the Problems

With the aim of solving the above-mentioned problems, the present invention provides a TiO₂-containing silica glass (hereinafter referred to as “TiO₂—SiO₂ glass of the present invention”) containing TiO₂ in an amount of from 5 to 10 mass % and at least one of B₂O₃, P₂O₅ and S in an amount of from 50 ppb by mass to 5 mass % in terms of the total content.

The TiO₂-containing silica glass of the present invention preferably has an annealing temperature of 1,100° C. or lower and an OH concentration of 600 ppm or less.

The TiO₂-containing silica glass of the present invention preferably has a standard deviation (dev[σ]) of a stress generated by striae of 0.03 MPa or less. The TiO₂-containing silica glass of the present invention preferably has a difference (Δσ) between the maximum value and the minimum value of the stress generated by striae of 0.20 MPa or less.

Further, the present invention provides an optical member for EUV lithography, using the TiO₂-containing silica glass of the present invention.

### Advantages of the Invention

The TiO₂—SiO₂ glass of the present invention can be prevented from generation of striae without causing a problem of devitrification or inclusion and therefore, is very suitable as an optical member for EUVL.

### BRIEF DESCRIPTION OF THE DRAWINGS

FIG. 1 is a graph plotting the relationship between CTE and temperature.

### MODE FOR CARRYING OUT THE INVENTION

The TiO₂—SiO₂ glass of the present invention is described below.

The TiO₂—SiO₂ glass of the present invention contains TiO₂ in an amount of from 5 to 10 mass % and at least one of B₂O₃, P₂O₅ and S in an amount of from 50 ppb by mass to 5 mass % in terms of the total content.

It is in the temperature region which can be experienced by a TiO₂—SiO₂ glass in use as an optical member for EUVL that the TiO₂—SiO₂ glass of the present invention is required to have a low coefficient of thermal expansion. From this viewpoint, the TiO₂—SiO₂ glass has a temperature (Cross-over Temperature; COT) at which the coefficient of thermal expansion (CTE) becomes 0 ppb/° C. being preferably from 15 to 110° C.

Also, in the TiO₂—SiO₂ glass of the present invention, the temperature width ΔT in which the coefficient of thermal expansion (CTE) becomes 0±5 ppb/° C. is preferably 5° C. or more. If ΔT is less than 5° C., in using the TiO₂—SiO₂ glass as an optical member of an exposure device for EUVL, thermal expansion of the optical member at the irradiation with EUV light may become a problem. The temperature width is more preferably 6° C. or more, still more preferably 8° C. or more, and yet still more preferably 15° C. or more.

In the case of using the TiO₂—SiO₂ glass of the present invention as an optical member for EUVL, the coefficient of thermal expansion (CTE) at the operating temperature is preferably 0±5 ppb/° C. The operating temperature of the optical member for EUVL differs depending on the application but is from 19 to 25° C. for a photomask and from 25 to 110° C. for a mirror.

The TiO₂—SiO₂ glass is known to change in the coefficient of thermal expansion according to the TiO₂ content (P. C. Schultz and H. T. Smyth, in: R. W. Douglas and B. Ellis, Amorphous Materials, Willey, New York, page 453 (1972)).

Therefore, COT and ΔT of the TiO₂—SiO₂ glass can be adjusted by controlling the TiO₂ content of the TiO₂—SiO₂ glass.

However, it is necessary to keep in mind that the TiO₂—SiO₂ glass of the present invention contains at least one of B₂O₃, P₂O₅ and S. Since B₂O₃, P₂O₅ and S are a component that increases the coefficient of thermal expansion of glass, in order to have the same coefficient of thermal expansion as that of the TiO₂—SiO₂ glass not containing B₂O₃, P₂O₅ and S, the TiO₂ content needs to be set high as compared with the glass not containing B₂O₃, P₂O₅, S and the like.

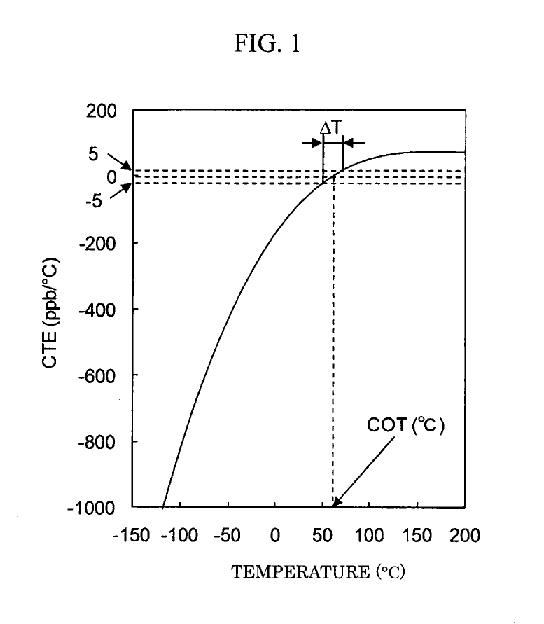

Incidentally, COT and ΔT of the TiO₂—SiO₂ glass can be determined by measuring CTE of the TiO₂—SiO₂ glass by a known measuring method, for example, by means of a laser interferometric dilatometer, in the range of from −150 to +200° C. and plotting the relationship between CTE and the temperature as shown in FIG. 1.

The TiO₂ content in the TiO₂—SiO₂ glass of the present invention is from 5 to 10 mass %. If the TiO₂ content is less than 5 mass % or exceeds 10 mass %, COT may not be present in the temperature range of from 15 to 110° C. Specifically, if the TiO₂ content is less than 5 mass %, COT tends to become less than 15° C. Also, if the TiO₂ content exceeds 10 mass %, COT tends to exceed 110° C. Furthermore, there is a possibility that a crystal such as rutile is readily precipitated or a bubble is liable to remain.

The TiO₂ content is preferably from 5.5 to 8 mass % and more preferably from 6 to 7 mass %.

In the TiO₂—SiO₂ glass of the present invention, B₂O₃, P₂O₅ and S are contained in an amount of from 50 ppb by mass to 5 mass % in terms of the total content so as to reduce the viscosity of the glass and prevent generation of striae. Since striae of the glass are attributable to the composition distribution, when the viscosity of the glass is decreased, diffusion of various components in the glass is promoted in the heating step performed in the process of producing the glass and the composition distribution is narrowed, as a result, striae are reduced. Accordingly, when at least one of B₂O₃, P₂O₅ and S is contained as a component for decreasing the viscosity of the glass, this makes it easy to reduce striae of the glass.

B₂O₃, P₂O₅ and S are themselves a component forming a network of the glass and therefore, unlike an alkali metal, an alkaline earth metal and the like used as a viscosity reducing dopant in Patent Document 1, those components do not cause growth of cristobalite as a crystal phase of SiO₂ or growth of rutile or anatase as a crystal phase of TiO₂ in the forming step of the glass, as a result, the problem of devitrification is eliminated. Also, the produced TiO₂—SiO₂ glass is free from the generation of an inclusion such as foreign matter and bubble.

In view of the effect of decreasing the viscosity of the glass and preventing generation of striae, among those three components above, it is more preferred to contain B₂O₃.

In the TiO₂—SiO₂ glass of the present invention, if the total content of B₂O₃, P₂O₅ and S is less than 50 ppb by mass, the effect of decreasing the viscosity of the glass becomes insufficient and generation of striae cannot be prevented. The total content is preferably 1 ppm by mass or more, more preferably 100 ppm by mass or more, and still more preferably 0.1 mass % or more.

On the other hand, if the total content of B₂O₃, P₂O₅ and S exceeds 5 mass %, there is a possibility that the coefficient of thermal expansion becomes large. The total content is preferably less than 2 mass % and more preferably less than 1 mass %.

In the TiO₂—SiO₂ glass of the present invention, apart from TiO₂, B₂O₃, P₂O₅, and S, the balance is SiO₂, but a component other than TiO₂, B₂O₃, P₂O₅, S, and SiO₂ may be incorporated. Examples of this component include a halogen such as F and Cl. Similarly to addition of B₂O₃ and P₂O₅, the addition of a halogen has an effect of decreasing the viscosity of the glass and contributes to preventing generation of striae. Also, the thermal expansion characteristics are improved by the addition of a halogen. Specifically, this addition produces an effect of, for example, decreasing the coefficient of thermal expansion or broadening ΔT. Among halogens, F having a high effect of decreasing the viscosity is preferably used.

However, F readily volatilizes, and a composition distribution may be thereby formed. In order to prevent the formation of a composition distribution due to volatilization of F, the content of F is preferably less than 50 ppm, and it is more preferred to substantially not contain this component.

The F concentration can be measured by a known method and, for example, can be measured through the following procedure. The TiO₂—SiO₂ glass is heated and melted in anhydrous sodium carbonate and to the obtained melt are added distilled water and hydrochloric acid each in a volume ratio of 1 based on the melt, to prepare a sample solution. The electromotive force of the sample solution is measured by a radiometer by using a fluorine F ion selective electrode and, as a comparative electrode, each of No. 945-220 and No. 945-468 manufactured by Radiometer Trading, and the F content is determined based on a calibration curve previously prepared by using an F ion standard solution (Journal of Chemical Society of Japan, 1972 (2), 350). Here, the detection limit in this method is 10 ppm.

When OH concentration in the TiO₂—SiO₂ glass is high, it is not preferred because a fictive temperature distribution is liable to be generated. Because, OH is present as a terminal group (OH group) cutting the network in the network structure of the glass and it is considered that as the number of terminal groups is larger, structural relaxation of the glass is more accelerated. That is, as the OH concentration is higher, the structural relaxation time is shorter and the fictive temperature is more susceptible to the temperature distribution in the TiO₂—SiO₂ glass, which is generated during cooling.

For the above reasons, the OH concentration of the TiO₂—SiO₂ glass of the present invention is preferably 600 ppm by mass or less, more preferably 200 ppm by mass or less, and still more preferably 50 ppm by mass or less.

The OH concentration of the TiO₂—SiO₂ glass can be measured by using a known method. For example, the OH concentration can be determined from an absorption peak at a wavelength of 2.7 μm after performing measurement by an infrared spectrophotometer (J. P. Williams, et al., American Ceramic Society Bulletin, 55(5), 524, 1976). The detection limit in this method is 0.1 ppm.

The effect obtained by containing at least one of B₂O₃, P₂O₅ and S in the TiO₂—SiO₂ glass of the present invention, that is, reduction in the viscosity of the glass, can be confirmed as a decrease of annealing temperature. Here, the annealing temperature means a temperature at which the viscosity η of the glass becomes 10¹³ dPa·s. The annealing temperature can be determined by measuring the viscosity of the glass by a beam bending method with a method in accordance with JIS R 3103-2:2001. In the TiO₂—SiO₂ glass of the present invention, the annealing temperature is preferably 1,120° C. or lower from the standpoint of reducing striae, more preferably 1,100° C. or lower, still more preferably 1,050° C. or lower, and yet still more preferably 1,000° C. or lower.

In this connection, when the annealing temperature is 1,120° C. or lower, this is also preferred in terms of facilitating the lowering of the fictive temperature.

In the TiO₂—SiO₂ glass of the present invention, the fictive temperature is preferably 1,100° C. or lower. If the fictive temperature exceeds 1,100° C., ΔT becomes narrow and can be hardly 5° C. or more. The fictive temperature is more preferably 1,000° C. or lower and still more preferably 950° C. or lower. For more broadening ΔT, the fictive temperature is preferably 900° C. or lower, more preferably 850° C. or lower, and still more preferably 800° C. or lower.

The fictive temperature of the TiO₂—SiO₂ glass can be measured by a known procedure. In Examples described later, the fictive temperature of the TiO₂—SiO₂ glass was measured through the following procedure.

With respect to a mirror polished TiO₂—SiO₂ glass, an absorption spectrum is obtained by using an infrared spectrometer (in Examples described later, Magna 760 manufactured by Nikolet was used). At this time, the data intervals are set to about 0.5 cm⁻¹, and an average value of 64 scannings is used as the absorption spectrum. In the thus-obtained infrared absorption spectrum, the peak observed in the vicinity of about 2,260 cm⁻¹ is derived from a harmonic overtone of stretching vibration of Si—O—Si bond of the TiO₂—SiO₂ glass. By using this peak position, a calibration curve is created using glasses each having a known fictive temperature and having the same composition, and the fictive temperature is determined. Alternatively, the reflection spectrum of the surface is measured in the same manner by using the same infrared spectrometer. In the thus-obtained infrared reflection spectrum, the peak observed in the vicinity of about 1,120 cm⁻¹ is derived from stretching vibration of Si—O—Si bond of the TiO₂—SiO₂ glass. By using this peak position, a calibration curve is created using glasses each having a known fictive temperature and having the same composition, and the fictive temperature is determined. Incidentally, a shift of the peak position due to change of the glass composition can be extrapolated from the composition dependency of the calibration curve.

In the TiO₂—SiO₂ glass of the present invention, the fictive temperature variation is preferably within 50° C. and more preferably within 30° C. If the fictive temperature variation exceeds the range above, a difference may arise in the coefficient of thermal expansion depending on the location.

In the present description, the “fictive temperature variation” is defined as a difference between the maximum value and the minimum value of the fictive temperature within 30 mm×30 mm in at least one plane.

The fictive temperature variation can be measured as follows. The TiO₂—SiO₂ glass is formed into a predetermined size and sliced to make a TiO₂—SiO₂ glass block of 50 mm×50 mm×1 mm, and the 50 mm×50 mm plane of the TiO₂—SiO₂ glass block is measured for the fictive temperature at intervals of a 10 mm pitch according to the above-described method, whereby the fictive temperature variation of the TiO₂—SiO₂ glass is determined.

In the TiO₂—SiO₂ glass of the present invention, standard deviation (dev[σ]) of the stress generated by striae is preferably 0.03 MPa or less within an area of 30 mm×30 mm in at least one plane. If the standard deviation exceeds 0.03 MPa, the surface roughness after polishing is increased, and an ultrahigh smoothness as high as surface smoothness (rms)≦1 nm may not be obtained. The standard deviation is more preferably 0.02 MPa or less, still more preferably 0.01 MPa or less.

In the TiO₂—SiO₂ glass of the present invention, difference (Δσ) between the maximum value and the minimum value of the stress generated by striae is preferably 0.20 MPa or less within an area of 30 mm×30 mm in at least one plane. If this difference exceeds 0.20 MPa, an outstanding composition distribution is created in the glass, and portions differing in the mechanical properties and chemical properties are generated in the glass, failing in making the polishing rate constant. In turn, the surface roughness after polishing is increased, and an ultrahigh smoothness as high as surface smoothness (rms)≦1 nm may not be obtained. The difference is more preferably 0.17 MPa or less, still more preferably 0.15 MPa or less, and yet still more preferably 0.10 MPa or less.

In the TiO₂—SiO₂ glass of the present invention, root mean square (RMS) of the stress level of striae is preferably 0.20 MPa or less within an area of 30 mm×30 mm in at least one plane. If the root mean square exceeds 0.20 MPa, the surface roughness after polishing may be increased, and an ultrahigh smoothness as high as surface smoothness (rms)≦1 nm may not be obtained. The root mean square is more preferably 0.17 MPa or less, still more preferably 0.15 MPa or less, and yet still more preferably 0.10 MPa or less.

The stress of striae of the TiO₂—SiO₂ glass can be obtained according to the following formula after determining retardation by a known method, for example, by measuring a region of about 1 mm×1 mm with use of a birefringent microscope.

Δ=C×F×n×d

Here, Δ is retardation, C is photoelastic constant, F is stress, n is refractive index, and d is sample thickness.

A stress profile is determined by the method above and from the profile, the standard deviation (dev[σ]), the difference (Δσ) between the maximum value and the minimum value, and the root mean square (RMS) can be obtained. More specifically, for example, a cube of about 40 mm×40 mm×40 mm is cut out from the TiO₂—SiO₂ glass, and the cube is sliced at each plane to a thickness of about 1 mm and polished to obtain a plate-shaped TiO₂—SiO₂ glass block of 30 mm×30 mm×0.5 mm. In a birefringent microscope, helium neon laser light is vertically applied to the 30 mm×30 mm plane of this glass block, and the retardation distribution in the plane is examined at an enlarged magnification large enough to sufficiently observe the striae and converted into a stress distribution. In the case where the pitch of striae is fine, the thickness of the plate-shaped TiO₂—SiO₂ glass block measured must be made thin.

In the TiO₂—SiO₂ glass of the present invention, fluctuation width (Δn) of refractive index within an area of 30 mm×30 mm in at least one plane is preferably 4.0×10⁻⁴ or less. If the fluctuation width exceeds 4.0×10⁻⁴, the surface roughness after polishing may be increased, and an ultrahigh smoothness as high as surface smoothness (rms)≦1 nm may not be obtained. The fluctuation width is more preferably 3.5×10⁻⁴ or less and still more preferably 3.0×10⁻⁴ or less. In particular, in order to attain the ultrahigh smoothness (surface smoothness (rms)≦2 nm), the fluctuation width (Δn) of refractive index is preferably 2×10⁻⁴ or less, more preferably 1×10⁻⁴ or less, and still more preferably 0.5×10⁻⁴ or less.

As for the measuring method of the fluctuation width Δn of refractive index, the measurement can be performed by a known method, for example, by using an optical interferometer. More specifically, for example, a cube of about 40 mm×40 mm×40 mm is cut out from the TiO₂—SiO₂ glass, and the cube is sliced at each plane to a thickness of about 0.5 mm and then polished to obtain a plate-shaped TiO₂—SiO₂ glass block of 30 mm×30 mm×0.2 mm. In a small-aperture Fizeau interferometer, only light at a specific wavelength is taken out of white light by using a filter and vertically applied to the 30 mm×30 mm plane of this glass block, and the refractive index distribution in the plane is examined at an enlarged magnification large enough to sufficiently observe the striae, thereby measuring the fluctuation width Δn of refractive index. In the case where the pitch of striae is fine, the thickness of the plate-shaped TiO₂—SiO₂ glass block measured must be made thin.

In the case of evaluating the striae by using the above-described birefringent microscope or optical interferometer, the size of one pixel in CCD may be not sufficiently small as compared with the width of striae, and the striae may not be detected. In this case, it is preferred that the entire region within an area of 30 mm×30 mm is divided into a plurality of microregions of, for example, about 1 mm×1 mm and the measurement is performed in each microregion.

In the TiO₂—SiO₂ glass of the present invention, fluctuation width of TiO₂ concentration (difference between the maximum value and the minimum value of the TiO₂ concentration) within an area of 30 mm×30 mm in one plane is preferably 0.06 mass % or less. If the fluctuation width exceeds 0.06 mass %, surface roughness after polishing is increased and an ultrahigh smoothness as high as surface smoothness (rms)≦1 nm may not be obtained. The fluctuation width is more preferably 0.04 mass % or less.

In the case of using the TiO₂—SiO₂ glass of the present invention as an optical member of an exposure device for EUVL, the fluctuation width of TiO₂ concentration (difference between the maximum value and the minimum value of the TiO₂ concentration) in the plane for optical use is preferably 0.13 mass % or less. If the fluctuation width exceeds 0.13 mass %, CTE variation may become excessively large. The fluctuation width is more preferably 0.10 mass % or less, still more preferably 0.06 mass % or less, and yet still more preferably 0.04 mass % or less.

The fluctuation width of TiO₂ concentration (difference between the maximum value and the minimum value of the TiO₂ concentration) is calculated from the maximum value and the minimum value in the composition distribution determined using an electron beam probe microanalyzer (EPMA).

The production method for the TiO₂—SiO₂ glass includes the following several methods. In one production method, TiO₂—SiO₂ glass fine particles (soot) obtained by flame hydrolysis or thermal decomposition of a silica precursor and a titania precursor each serving as a glass-forming raw material is deposited and grown by a soot process to obtain a porous TiO₂—SiO₂ glass body. The obtained porous TiO₂—SiO₂ glass body is heated to a temperature of densification temperature or higher under reduced pressure or in a helium atmosphere and further heated to a temperature of transparent vitrification temperature or higher, thereby obtaining TiO₂—SiO₂ glass.

The TiO₂—SiO₂ glass of the present invention contains at least one of B₂O₃, P₂O₅ and S and therefore, the TiO₂—SiO₂ glass fine particle (soot) is produced by simultaneously mixing and supplying at least one of their precursors, that is, a B₂O₃ precursor, a P₂O₅ precursor and an S precursor in addition to the silica precursor and the titania precursor.

Examples the B₂O₃ precursor which can be used include BC1₃ and BF₃. Examples of the P₂O₅ precursor which can be used include a phosphorus oxyhalide such as POCl₃, and a trialkyl phosphate such as P(CH₃O)₃. Examples of the S precursor which can be used include SCl₂ and SF₆.

The soot process includes an MCVD process, an OVD process, a VAD process and the like according to the preparation manner.

Also, there is a production method where a silica precursor and a titania precursor each serving as a glass-forming raw material are hydrolyzed-oxidized in an oxyhydrogen flame of from 1,800 to 2,000° C. to obtain TiO₂—SiO₂ glass by a direct process. The TiO₂—SiO₂ glass of the present invention contains at least one of B₂O₃, P₂O₅ and S and therefore, the TiO₂—SiO₂ glass is obtained by simultaneously mixing and supplying at least one of their precursors, that is, a B₂O₃ precursor, a P₂O₅ precursor and an S precursor in addition to the silica precursor and the titania precursor.

In the present description, the densification temperature means a temperature at which the porous glass body can be densified to such an extent that a void cannot be confirmed by an optical microscope. Also, the transparent vitrification temperature means a temperature at which a crystal cannot be confirmed by an optical microscope and a transparent glass is obtained.

In the TiO₂—SiO₂ glass of the present invention, generation of striae is suppressed by containing at least one of B₂O₃, P₂O₅ and S as a component for reducing the viscosity of the glass. In order to prevent production of an inclusion such as crystal foreign matter, B₂O₃ or S is preferred. Also, for obtaining TiO₂—SiO₂ glass reduced in striae, it is preferred to further keep in mind the following points.

In order to obtain TiO₂—SiO₂ glass reduced in striae, the temperature of piping for conveying raw materials, particularly, piping for conveying a titania precursor, is preferably controlled tightly. In the case of gasifying the titania precursor in a high concentration by bubbling, it is effective for reduction of striae to set the piping at a higher temperature than the bubbling temperature such that the temperature rises as it comes closer to a burner.

Also, a temperature fluctuation in the piping may give rise to striae. For example, in the piping for conveying TiCl₄ at 0.5 msec, when the temperature of gas in a portion of piping having a length of 2 m fluctuates with a period of 30 seconds at 130° C.±1.5° C., a composition fluctuation of 0.1 mass % is generated. Accordingly, in order to obtain TiO₂—SiO₂ glass reduced in striae, the temperature of piping for conveying a titania precursor is preferably kept to a fluctuation width within ±1° C. by PID control. The fluctuation width of temperature is more preferably within ±0.5° C. Not only the piping for conveying a titania precursor, but also the temperature of piping for conveying a silica precursor is preferably kept to a fluctuation width within ±1° C. by PID control. The fluctuation width of temperature is more preferably within ±0.5° C. For heating the piping, a flexible heater such as ribbon heater or rubber heater is preferably wound around the piping, because the piping is uniformly heated, but for achieving more uniform heating, the piping and the heater are preferably covered with an aluminum foil. Also, the outermost layer is preferably covered with a heat insulator such as urethane and heat-resistant fiber cloth. In addition, in order to reduce the composition fluctuation, the gas flow velocity in piping is preferably accelerated. The flow velocity is preferably 0.1 msec or more, more preferably 0.3 msec or more, still more preferably 0.5 msec or more, and yet still more preferably 1 msec or more, in terms of volume as converted into atmospheric pressure at the temperature there.

In order to uniformly supply a gas, a mechanism for stirring the gas is preferably provided before various precursors each serving as a glass raw material are supplied to a burner. As the stirring mechanism, two kinds of mechanisms may be considered, that is, one is a mechanism of fractionating the gas by a component such as static mixer and filter and combining the gas fractions, and another is a mechanism of supplying the gas after averaging fine fluctuations by introducing the gases into a large space. In order to obtain TiO₂—SiO₂ glass reduced in striae, the glass is preferably produced by using at least one of the above-described stirring mechanisms, and it is more preferred to use both. Also, out of stirring mechanisms, both a static mixer and a filter are preferably used.

For producing the TiO₂—SiO₂ glass of the present invention, a production method including the following steps (a) to (e) can be employed.

### Step (a):

TiO₂—SiO₂ glass fine particles obtained by flame-hydrolyzing a silica precursor, a titania precursor and at least one precursor of B₂O₃, P₂O₅ and S, each serving as a glass-forming raw material, are deposited and grown on a substrate to form a porous TiO₂—SiO₂ glass body. Out of the glass-forming raw materials, the B₂O₃ precursor, the P₂O₅ precursor and the S precursor are as described above. The silica precursor includes a silicon halide compound, for example, a chloride such as SiCl₄, SiHCl₃, SiH₂Cl₂ and SiH₃Cl, a fluoride such as SiF₄, SiHF₃ and SiH₂F₂, a bromide such as SiBr₄ and SiHBr₃, and an iodide such as SiI₄; and an alkoxysilane represented by RₙSi(OR)₄₋ₙ (wherein each R is independently an alkyl group having a carbon number of 1 to 4, and n is an integer of from 0 to 3). The titania precursor includes a titanium halide such as TiCl₄ and TiBr₄, and an alkoxytitanium represented by RₙTi(OR)₄₋ₙ (wherein each R is independently an alkyl group having a carbon number of 1 to 4, and n is an integer of from 0 to 3). As the silica precursor and titania precursor, a compound of Si and Ti, such as silicon titanium double alkoxide, may be also used.

As the substrate, use can be made a silica glass-made seed rod (for example, the seed rod described in JP-B-63-24973). The substrate is not limited to a rod shape, but a plate-shaped substrate may be also used.

### Step (b):

The porous TiO₂—SiO₂ glass body obtained in the step (a) is heated to densification temperature under reduced pressure of 13,000 Pa or less or in an atmosphere containing helium as the main component (50% or more) to obtain a TiO₂—SiO₂ dense body. The densification temperature is usually from 1,250 to 1,550° C., preferably from 1,300 to 1,500° C.

### Step (c):

The TiO₂—SiO₂ dense body obtained in the step (b) is heated to transparent vitrification temperature to obtain a transparent TiO₂—SiO₂ glass body. The transparent vitrification temperature is usually from 1,350 to 1,800° C., preferably from 1,400 to 1,750° C.

The atmosphere is preferably an atmosphere of 100% of an inert gas such as helium and argon, or an atmosphere where an inert gas such as helium and argon is the main component (50% or more). The pressure may be reduced pressure or normal pressure. In the case of reduced pressure, the pressure is preferably 13,000 Pa or less.

### Step (d):

The transparent TiO₂—SiO₂ glass body obtained in the step (c) is heated to a temperature of softening point or higher and formed into a desired shape to obtain a formed TiO₂—SiO₂ glass body. The forming temperature is preferably from 1,500 to 1,800° C. If the forming temperature is 1,500° C. or lower, the transparent TiO₂—SiO₂ glass comes to have high viscosity and substantially fails in undergoing deformation by its own weight. Also, growth of cristobalite as a crystal phase of SiO₂ or growth of rutile or anatase as a crystal phase of TiO₂ occurs, and so-called devitrification is caused. If the forming temperature 1,800° C. or more, sublimation of SiO₂ cannot be neglected.

It is also possible to perform the step (c) and the step (d) continuously or simultaneously.

In order to adjust the fictive temperature of the TiO₂—SiO₂ glass of the present invention to 1,100° C. or lower, a method of holding the formed TiO₂—SiO₂ glass body formed into a desired shape in the step (d), at a temperature of 600 to 1,200° C. for 2 hours or more, and then lowering the temperature to 700° C. or lower at an average cooling rate of 10° C./hr or less, is effective. For more decreasing the fictive temperature, the temperature is preferably lowered at a rate of 5° C./hr, and still more preferably at a rate of 3° C./hr. When the temperature is lowered as a lower average cooling rate, a lower fictive temperature is achieved. For example, when the temperature is lowered at a rate of 1° C./hr or less, the fictive temperature can be 900° C. or lower. In this case, the glass body is cooled at a low cooling rate only in the temperature range of 1,000 to 800° C., for example, at a rate of 1° C./hr or less, and in other temperature regions, cooled at a cooling rate of 5° C./hr or more, whereby the time can be shortened. The atmosphere here is preferably an atmosphere of 100% of an inert gas such as helium, argon, and nitrogen, an atmosphere containing this inert gas as the main component, or an air atmosphere. The pressure is preferably reduced pressure or normal pressure.

### EXAMPLES

The present invention is described in greater detail below by referring to Examples, but the present invention is not limited thereto. Examples 1 to 3 are Examples of the invention, and others are Comparative Examples.

### Example 1

TiO₂—SiO₂ glass fine particles obtained by mixing TiCl₄, SiCl₄ and BCl₃ as glass-forming raw materials each after gasification and thermal hydrolyzing the mixture in an oxyhydrogen flame (flame hydrolysis) was deposited and grown on a substrate to form a porous TiO₂—SiO₂ glass body (step (a)).

Since the obtained porous TiO₂-SiO₂ glass body was difficult to handle directly, the glass body in the state of being still deposited on the substrate was held at 1,200° C. for 4 hours in the air and then removed from the substrate. Thereafter, the porous TiO₂—SiO₂ glass body was placed in an electric furnace capable of controlling the atmosphere, and the pressure was reduced to 10 Torr at room temperature. Subsequently, the temperature was raised to 1,450° C. in a helium gas atmosphere, and the system was held at this temperature for 4 hours to obtain a TiO₂—SiO₂ dense body (step (b)).

The obtained TiO₂—SiO₂ dense body was heated to 1,700° C. in an argon atmosphere by using a carbon furnace to obtain a transparent TiO₂—SiO₂ glass body (step (c)).

The obtained transparent TiO₂—SiO₂ glass body was heated to 1,750° C. and formed into a desired shape to obtain a formed TiO₂—SiO₂ glass body (step (d)).

The obtained transparent TiO₂—SiO₂ glass body was held at 1,100° C. for 10 hours and cooled to 500° C. at a rate of 3° C./hr, and then, allowed to cool in the air.

### Example 2

A TiO₂—SiO₂ glass body was obtained in the same manner as in Example 1 except for using POCl₃ as the glass-forming raw material in place of BCl₃.

### Example 3

A TiO₂—SiO₂ glass body was obtained in the same manner as in Example 1 except for using SCl₂ as the glass-forming raw material in place of BCl₃.

### Example 4

A TiO₂—SiO₂ glass body was obtained in the same manner as in Example 1 except for changing the amount of BCl₃ supplied such that the content of B₂O₃ in the obtained TiO₂—SiO₂ glass takes the value shown in Table 1.

### Example 5

A TiO₂—SiO₂ glass body was obtained in the same manner as in Example 1 except for using sodium tetrabutoxide as the glass-forming raw material in place of BCl₃.

The contents of individual components in the TiO₂—SiO₂ glass bodies obtained in Examples 1 to 5 are shown in Table 1. In the Table, the unit of the content is mass %. Also, in each TiO₂—SiO₂ glass body, apart from the components shown in the Table, the balance is SiO₂.

The TiO₂ concentration was determined by a fundamental parameter (FP) method using a fluorescent X-ray. The contents of B₂O₃, P₂O₅ and Na₂O were determined by ICP mass spectrometry. The S content was determined by ion chromatography.

Also, with respect to the TiO₂—SiO₂ glass bodies obtained in Examples 1 to 5, the viscosity of the glass was measured by a beam bending method with a method in accordance with JIS R 3103-2:2001, and the temperature at which the viscosity η of the glass became 10¹³ dPa·s was taken as the annealing temperature. The results are shown in Table 1. In addition, with respect to the TiO₂—SiO₂ glass bodies obtained in Examples 1 to 5, the presence or absence of crystallization was confirmed with a visual inspection. The results are shown in Table 1.

TABLE 1

| | Example 1 | Example 2 | Example 3 | Example 4 | Example 5 |
|---|---|---|---|---|---|
| TiO₂ | 7.6 | 7.2 | 6.9 | 6.9 | 6.9 |
| B₂O₃ | 0.3 | 0 | 0 | 0.09 | 0 |
| P₂O₅ | 0 | 0.5 | 0 | 0 | 0 |
| S | 0 | 0 | 0.1 | 0 | 0 |
| Na₂O | 0 | 0 | 0 | 0 | 0.1 |
| Annealing | 1075 | 1080 | 1090 | 1095 | 1090 |
| Temperature | | | | | |
| (° C.) | | | | | |
| Crystalliza- | none | none | none | none | observed |
| tion | | | | | |

As apparent from Table 1, in the TiO₂—SiO₂ glass bodies of Examples 1 to 4 where B₂O₃, P₂O₅ or S was contained as a component for reducing the viscosity of the glass, the annealing temperature was at the same level as that of the TiO₂—SiO₂ glass body of Example 5 where Na₂O was contained, revealing that the addition of B₂O₃, P₂O₅ or S is effective in reducing the viscosity of the glass. In the TiO₂—SiO₂ glass body of Example 5, crystallization of glass, giving rise to devitrification, was confirmed, but in the TiO₂—SiO₂ glass bodies of Examples 1 to 4, crystallization of glass was not observed.

While the invention has been described in detail and with reference to specific embodiments thereof, it will be apparent to one skilled in the art that various changes and modifications can be made therein without departing from the spirit and scope of the invention.

This application is based on Japanese Patent Application No. 2009-273340 filed on Dec. 1, 2009, the contents of which are incorporated herein by way of reference.

1. A TiO₂-containing silica glass containing TiO₂ in an amount of from 5 to 10 mass % and at least one of B₂O₃, P₂O₅ and S in an amount of from 50 ppb by mass to 5 mass % in terms of the total content.

2. The TiO₂-containing silica glass according to claim 1, having an annealing temperature of 1,100° C. or lower and an OH concentration of 600 ppm or less.

3. The TiO₂-containing silica glass according to claim 1, having a standard deviation (dev[σ]) of a stress generated by striae of 0.03 MPa or less.

4. The TiO₂-containing silica glass according to claim 1, having a difference (Δσ) between the maximum value and the minimum value of a stress generated by striae of 0.20 MPa or less.

5. An optical member for EUV lithography, using the TiO₂-containing silica glass according to claim 1.
